(19) United States
(12) Patent Application Publication
(10) Pub. No.: US 2018/0247509 A1
(43) Pub. Date: Aug. 30, 2018

(54) System and Method for Associating Identification and/or Security Tags With a User, and Assigning Such Tags to One or More Products

(71) Applicants: Zvika ASHKENAZI, Cupertino, CA (US); Christian DELAY, San Jose, CA (US)

(72) Inventors: Zvika ASHKENAZI, Cupertino, CA (US); Christian DELAY, San Jose, CA (US)

(73) Assignee: Thin Film Electronics ASA, Oslo (NO)

(21) Appl. No.: 15/904,178

(22) Filed: Feb. 23, 2018

Related U.S. Application Data
(60) Provisional application No. 62/463,605, filed on Feb. 25, 2017.

(51) Int. Cl. G08B 13/24; G06K 7/14; G06K 7/10

(52) U.S. Cl. CPC G08B 13/2402; G06K 7/1417; H04W 88/02; G06K 7/10297; G06K 7/1413

(57) ABSTRACT

A computer-implemented method and system for associating one or more wireless tags with one or more products is disclosed. The method comprises communicating wirelessly with the wireless tag(s) using a mobile device, associating the wireless tag(s) with a user account, and assigning at least one of the wireless tag(s) to a current product or a new product. The system comprises one or more wireless tags, a mobile device configured to communicate wirelessly with the wireless tag(s), and a storage server or cloud computer configured to (i) send, receive and store the information regarding the wireless tag(s) and the associated product and (ii) store and execute an analytics program or web application configured to track the information regarding the wireless tag(s). A computer-readable storage medium enabling the method on the mobile device and a system for managing one or more wireless tags associated with one or more products are also disclosed.

### CROSS REFERENCE TO RELATED APPLICATION(S)

This application claims the benefit of U.S. Provisional Patent Application No. 62/463,605, filed on Feb. 25, 2017, incorporated herein by reference as if fully set forth herein.

### FIELD OF THE INVENTION

The present invention generally relates to the field(s) of product security and authentication. More specifically, embodiments of the present invention pertain to a computer-implemented method for associating one or more wireless security and/or identification tags with a user and assigning such tags to one or more products, a system for associating one or more wireless security and/or identification tags with a user and assigning such tags to one or more products, a tangible computer-readable storage medium storing a set of instructions executed by a processor on a mobile device to implement such a method, and a system for managing wireless security and/or identification tags assigned to one or more products.

### DISCUSSION OF THE BACKGROUND

Wireless near field communication (NFC) and radio frequency (RF) security and/or identification tags are used to digitally track and manage products by their manufacturers and distributors. Such wireless tags are often associated with a product by a manufacturer of the tag, and subsequently shipped to the manufacturer or distributor of the product.

There is a need for a wireless security and/or identification tag management system in which the wireless tags are quickly and facilely associated with a product by the manufacturer, packager, distributor, or reseller of the product, as opposed to being pre-associated by the tag manufacturer before shipment to the product manufacturer or distributor.

Additionally, there is a need for manufacturers, distributors and resellers to customize the wireless tag management system (e.g., to control the user experience for a given product). For example, the manufacturer or distributor may want a user to see a customized response screen on their mobile device when communicating with a tag on a particular product at a particular time, or under particular conditions, as opposed to a generic response screen.

This “Discussion of the Background” section is provided for background information only. The statements in this “Discussion of the Background” are not an admission that the subject matter disclosed in this “Discussion of the Background” section constitutes prior art to the present disclosure, and no part of this “Discussion of the Background” section may be used as an admission that any part of this application, including this “Discussion of the Background” section, constitutes prior art to the present disclosure.

### SUMMARY OF THE INVENTION

An advantage of the present invention includes the ability to automatically associate one or more wireless security or identification tags with a product (e.g., a bottle of wine, a jar of medicine, or an article of clothing). Such wireless tags may also store information regarding the product (e.g., the product name or date of manufacture), and in some cases, may have a security feature that detects whether the product is opened or closed (e.g., by detecting the continuity state of a package or container using a sensor).

A user may communicate with a wireless tag using a reader in an enabled mobile device. For example, when the wireless tag is a near field communication (NFC) tag, the user may bring the mobile device to a distance within a couple of centimeters of (e.g., “tap”) the NFC tag for the mobile device to communicate with the tag. The user may associate the tag with a particular user account and assign the wireless tag to a product using a stand-alone and/or web-browser application or program on the mobile device. The mobile device may transmit identification, security, and/or product information to a server (e.g., a cloud server and/or storage device) that stores such information. The user may associate a group of wireless tags (e.g., all tags found on the same sheet or roll) with a product by tapping only one wireless tag in the group, or may associate a specific number of wireless tags from the same group by tapping on as few as two tags (e.g., by tapping on the first tag and the last tag in the group to associate the first tag, the last tag, and all tags between the first tag and the last tag in the group).

A wireless tag may be an owned tag or a give-away tag. Owned tags are associated with a user account before they are received by the user. Give-away tags are not associated with a user account prior to receipt by the user, and the user may associate the tag with his or her account using the mobile device. Give-away tags may be distributed as commodity items, or given away at conferences or demonstrations.

A manufacturer, distributor, or reseller of a product may want to manage the tags associated with his or her account, as well as orders or shipments of tags. A tag management program or web application may be used to view and edit information regarding currently associated tags and orders and/or shipments of tags.

A tag manufacturer or manufacturer, reseller, distributor or user of a product may want to track the usage and/or distribution of the product. An analytics program or web application may be used to view tag information such as taps per time period (e.g., how many tags were tapped in one day or one week), total taps on a given tag (cumulatively or during a particular time period), the locations of the taps on a tag or a group of tags (e.g., a map displaying how many taps occurred in a particular city, state, province or country), etc.

Thus, in one aspect, the present invention relates to a computer-implemented method for associating one or more wireless tags with one or more products, comprising communicating wirelessly with the wireless tag(s) using a mobile device, associating the tag(s) with a user account using a configuration website or an application on the mobile device, and assigning at least one of the wireless tag(s) to a current product or a new product using the configuration website or the application on the mobile device.

In general, each of the wireless tags is a wireless identification tag. In various embodiments, each of the wireless (identification) tags is an owned tag or a give-away tag. The owned tag may be associated with the user account before the mobile device communicates with the owned tag.

In some embodiments, the method further comprises navigating to the configuration website or the application on the mobile device after communicating with at least one of the wireless tags using the mobile device, registering or signing in to the user account using the configuration website or the application on the mobile device, and/or downloading the application from a server onto the mobile device. In other or further embodiments, the method may comprise assigning the wireless tags to the current product or the new product using the application on the mobile device.

In some embodiments, the method may comprise (i) assigning the wireless tags to the new product and (ii) entering a name for (e.g., naming) the new product, entering or typing a uniform resource locator (URL; e.g., that is linked to a name and/or description of the new product), or selecting the new product from a list of previous, current or favorite products using a graphical user interface (GUI) on the mobile device. In other embodiments, assigning the wireless tags to the new product comprises scanning a quick response (QR) code or universal product code (UPC) using the mobile device, scanning a different wireless tag assigned to the same product using the mobile device, or describing or defining the new product using voice or image recognition on the mobile device. In further embodiments, the method may comprise uploading information related to the new product to a storage server or a cloud computer using the mobile device and a network connected to the mobile device.

In some embodiments concerning a group of wireless tags, assigning the group of wireless tags comprises communicating with a first wireless tag and a last wireless tag in the group using the mobile device. In at least one configuration, this can assign the first wireless tag, the last wireless tag, and all wireless tags between the first and last wireless tags to the current product or the new product. In some examples, the group of wireless tags may comprise a roll of wireless tags.

In various embodiments, the wireless tags may comprise one or more near-field communication (NFC), radio frequency (RF), high frequency (HF), very high frequency (VHF), or ultra high frequency (UHF) tags. The mobile device may comprise a smart phone configured to communicate wirelessly with the wireless tags. The tags may be associated with the user account using the application on the mobile device.

In another aspect, the present invention relates to a system for associating one or more wireless tags with one or more products, the system comprising the wireless tag(s), a mobile device configured to communicate wirelessly with the wireless tag(s), the mobile device having a processor and a memory configured to store and execute an application configured to assign the wireless tag(s) to a product, display information regarding the wireless tag(s) and the product, and optionally associate the wireless tags with a user account, and a storage server or cloud computer configured to (i) send, receive and store the information regarding the wireless tag(s) and the associated product and (ii) store and execute an analytics program or web application configured to track the information regarding the wireless tag(s). As for the above method, each of the wireless tags may be a wireless identification tag, and each of the wireless (identification) tags may be an owned tag or a give-away tag, as described herein.

In various embodiments, the mobile device may be configured to navigate to the application after communicating with at least one of the wireless tags, and/or the application may be further configured to enable a user to register or sign in to the user account before the user can assign the wireless tag(s) to the product. In further or other embodiments, the mobile device may be further configured to download the application from a server onto the mobile device.

As for the above method, the product may be a current product or a new product. The application may be further configured to assign at least one of the wireless tags to the new product by entering a name for the new product, entering or typing a uniform resource locator (URL), or selecting the new product from a list of previous or favorite products, as described herein. Alternatively, the application may be further configured to assign at least one of the wireless tags to the new product by scanning a quick response (QR) code or universal product code (UPC) using the mobile device, scanning a different wireless tag assigned to the same product using the mobile device, or describing or defining the new product using voice or image recognition on the mobile device. In further embodiments, the application may be further configured to upload information related to the new product to a storage server or a cloud computer using the mobile device and a network connected to the mobile device.

In various embodiments, the application is further configured to assign at least one of the wireless tags to the new product by selecting the new product from a list of current products displayed on a graphical user interface (GUI) on the mobile device. In embodiments concerning a group of wireless tags, the application may be configured to assign a first wireless tag, a last wireless tag, and all tags between the first and the last of the wireless tags to the current product or the new product (e.g., when the mobile device communicates with the first and last wireless tags). The wireless tags in the present system may have any or all of the attributes, properties, functions and/or characteristics of the tags described with respect to the present method for associating the tag(s) with one or more products.

In a further aspect, the present invention relates to a tangible computer-readable storage medium storing a set of instructions, which when executed by a processor on a mobile device cause the processor and/or the mobile device to at least enable a user to communicate with one or more wireless tags using the mobile device, navigate to a configuration website or an application on the mobile device after communicating with the wireless tag(s), and enable the user to assign the wireless tag(s) to a current product or a new product using the configuration website or the application on the mobile device. The wireless tags affected by, read, or assigned using the present set of instructions may have any or all of the attributes, properties, functions and/or characteristics of the tags described with respect to the present method and/or system for associating the tag(s) with one or more products.

In various embodiments, the set of instructions may further include at least one instruction to (i) associate the owned tag with the user account before the mobile device communicates with the owned tag; (ii) navigate to the configuration website or the application on the mobile device after the mobile device communicates with the wireless tags; (iii) prompt a user to register or sign in to the user account using the configuration website or the application on the mobile device; (iv) download the application from a server onto the mobile device when the mobile device does not include the application; and/or (v) assign at least one of the wireless tags to a new product.

In some embodiments, the instruction(s) to assign at least one of the wireless tags to the new product comprises at least one instruction to (1) enable the user to name the new product, enter or type a uniform resource locator (URL), or select the new product from a list of previous, current or favorite products, as described herein; (2) enable the user to scan a quick response (QR) code or universal product code (UPC) (e.g., linked to a name and/or description of the new product) using the mobile device; (3) scan a different wireless tag assigned to the same product using the mobile device, or (4) describe or define the new product using voice or image recognition on the mobile device. In other or further embodiments, the set of instructions may further include at least one instruction to (a) upload information related to the new product to a storage server or a cloud computer using the mobile device and a network connected to the mobile device, and/or (b) assign at least one of wireless tags to a current product. In embodiments relating to a group of wireless tags, the instruction(s) to assign the wireless tag(s) to the new product may comprise at least one instruction to enable the user to assign the group of wireless tags by communicating with a first wireless tag and a last wireless tag in the group using the mobile device.

In yet another aspect, the present invention relates to a system for managing one or more wireless tags (which may have any or all of the attributes, properties, functions, and/or characteristics of the tags described with respect to the present method and/or system for associating the tag[s] with product[s]) associated with one or more products. The system comprises the wireless tag(s), a mobile or stationary device configured to communicate with the wireless tag(s), and a storage server or cloud computer configured to send, receive or store the information regarding the wireless tag(s) and a product associated with the wireless tags. The mobile or stationary device comprises a program or web application configured to access, track and manipulate information regarding the wireless tags and the associated product.

### BRIEF DESCRIPTION OF THE DRAWINGS

FIGS. 1-3 are a flow chart showing exemplary methods for associating one or more wireless tags with a user account and assigning the tag(s) to one or more products in accordance with one or more embodiments of the present invention.

FIG. 4 is an exemplary diagram showing a system for associating one or more wireless tags with a user and assigning the tag(s) to one or more products in accordance with one or more embodiments of the present invention.

FIG. 5 is an exemplary display on the GUI of a mobile device enabling a user to register or log into a user account in accordance with one or more embodiments of the present invention.

FIG. 6 is an exemplary display on the GUI of a mobile device enabling a user to create a new product in accordance with one or more embodiments of the present invention.

FIG. 7 is an exemplary display on the GUI of a mobile device enabling a user to view and select one or more tags that have yet to be assigned to a product in accordance with one or more embodiments of the present invention.

FIG. 8A is an exemplary display on the GUI of a mobile device enabling a user to find and/or identify an assigned and/or associated tag by scanning in accordance with one or more embodiments of the present invention.

FIG. 8B is an exemplary display on the GUI of a mobile device showing a tag found and/or identified using the display in FIG. 8A in accordance with an embodiment of the present invention.

FIG. 9 is an exemplary display on the GUI of a mobile device enabling a user to edit and/or unassign one or more tags in accordance with one or more embodiments of the present invention.

FIG. 10 is an exemplary display on the GUI of a mobile device enabling a user to view the number of taps over various time periods for tags assigned to a particular product in accordance with one or more embodiments of the present invention.

FIGS. 11A-B are exemplary displays on the GUI of a mobile device showing whether the packaging or container for a particular product is sealed or opened in accordance with one or more embodiments of the present invention.

FIG. 12A is an exemplary display on the GUI of a computer or a mobile device enabling a user to view and manage wireless tag information in accordance with one or more embodiments of the present invention.

FIG. 12B is an exemplary display on the GUI of a computer or a mobile device enabling a user to view and manage orders and/or shipments of wireless tags in accordance with one or more embodiments of the present invention.

FIG. 12C is an exemplary display on the GUI of a computer or a mobile device enabling a user to track the number of taps over various different time periods (and optionally in a given geographic location or area) for a given product in accordance with one or more embodiments of the present invention.

### DETAILED DESCRIPTION

Reference will now be made in detail to various embodiments of the invention, examples of which are illustrated in the accompanying drawings. While the invention will be described in conjunction with the following embodiments, it will be understood that the descriptions are not intended to limit the invention to these embodiments. On the contrary, the invention is intended to cover alternatives, modifications and equivalents that may be included within the spirit and scope of the invention. Furthermore, in the following detailed description, numerous specific details are set forth in order to provide a thorough understanding of the present invention. However, it will be readily apparent to one skilled in the art that the present invention may be practiced without these specific details. In other instances, well-known methods, procedures and components have not been described in detail so as not to unnecessarily obscure aspects of the present invention. Furthermore, it should be understood that the possible permutations and combinations described herein are not meant to limit the invention. Specifically, variations that are not inconsistent may be mixed and matched as desired.

In the context of this application, the term “signal” refers to any known structure, construction, arrangement, technique, method and/or process for physically transferring data or information from one point to another. Unless indicated otherwise from the context of its use herein, the terms “information” and “data” may be used interchangeably, although each term is generally given its art-recognized meaning. Furthermore, unless indicated otherwise from the context of its use herein, the terms “coupled to,” “connected to,” and “in communication with” (and grammatical variations thereof) may be used interchangeably and indicate both direct and indirect couplings, connections and communications, but each term is also generally given its art-recognized meaning. Unless indicated otherwise from the context of its use herein, the terms “known,” “fixed,” “given,” “certain” and “predetermined” generally refer to a value, quantity, parameter, constraint, condition, state, process, procedure, method, practice, or combination thereof that is, in theory, variable, but is typically set in advance and not varied thereafter when in use.

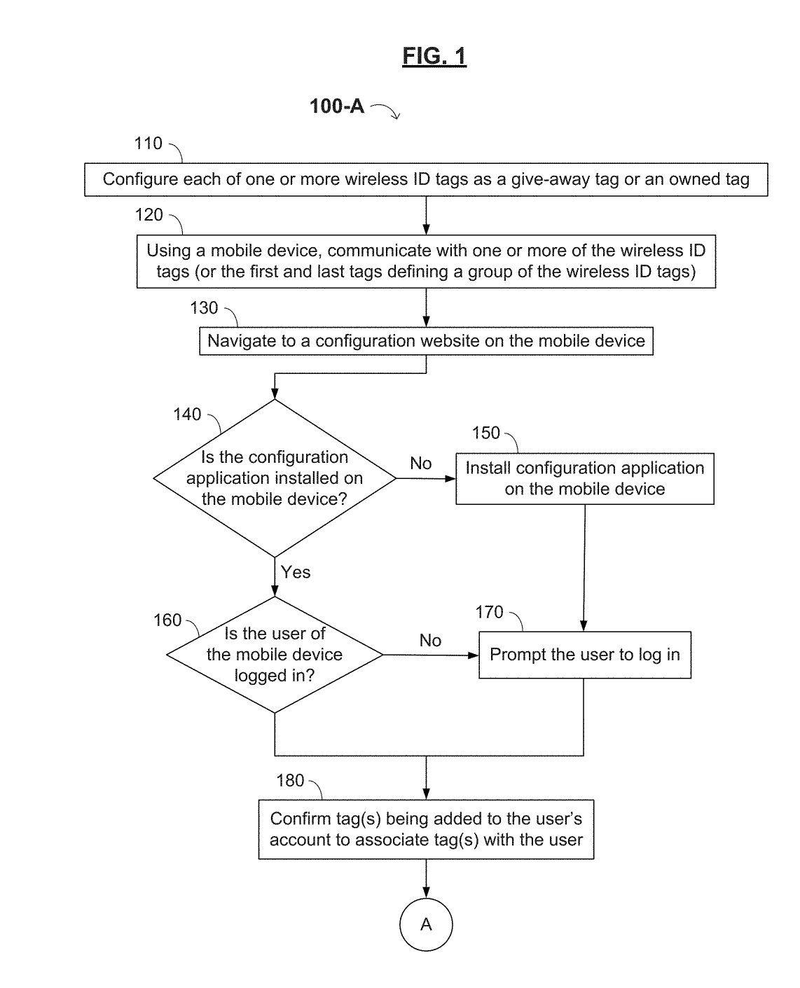

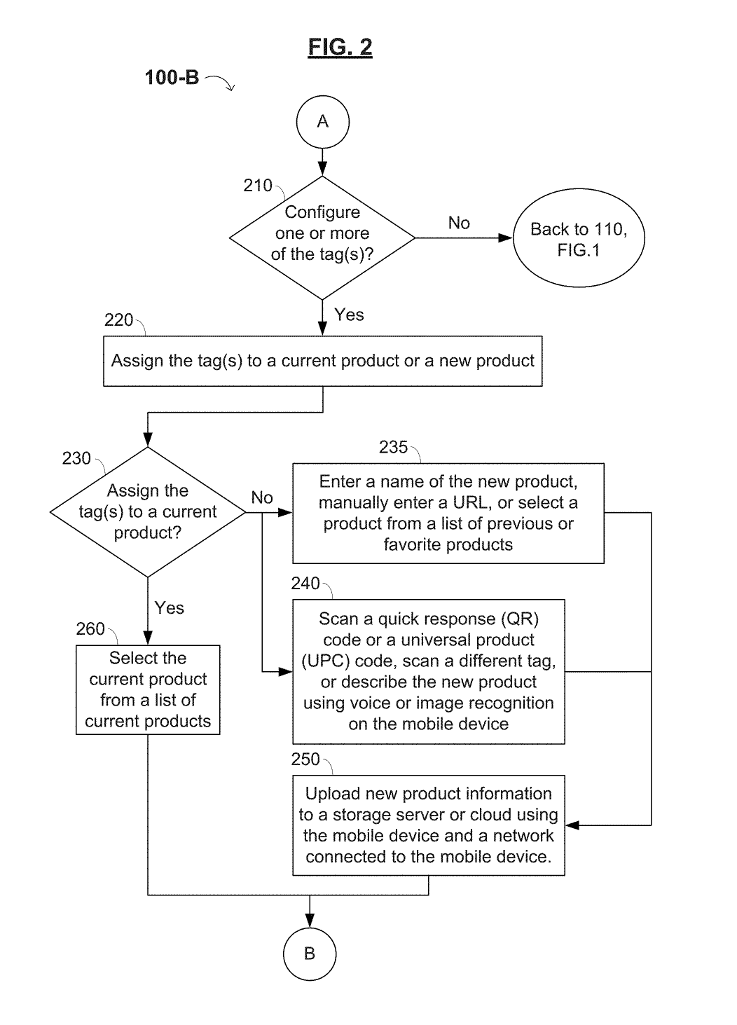

FIG. 1 shows a flow chart 100-A describing an exemplary method of associating one or more wireless tags with a user account.

At 110, each of one or more wireless tags may be configured as an owned tag or a give-away tag. The wireless tags may be security tags (e.g., the tags may detect whether a product container has been opened or closed, or may indicate that the product is authentic) and/or identification tags (e.g., the tags uniquely identify the product in the container). The wireless tags may be near field communication (NFC) or radio frequency (RF or RFID) tags, or may use other wireless protocols, wavelengths or wavelength bands, such as high frequency (HF), very high frequency (VHF), or ultra high frequency (UHF).

Owned tags are associated with a user account by the manufacturer of the tags before receipt by the user (e.g., a product manufacturer, distributor, reseller, packager, end user [consumer], etc.). Give-away tags are not pre-associated with a user account, and may be associated with a user account by the user of the mobile device. Give-away tags may be given away at conferences or demonstrations or as samples, or may be sold as a commodity item.

The user may associate a single tag or a group of tags with a user account. The user may associate a whole group of tags (e.g., all tags on the same roll or sheet) by communicating with one tag in the group of tags. The user may associate a plurality of tags, but less than all tags in a group (e.g., a subgroup of tags) by communicating with a first tag in the subgroup and a last tag in the subgroup, thereby associating the first tag, the last tag, and all tags between the first and last tags. Physically, owned tags and give-away tags are generally the same. However, in one embodiment, the user is not able to associate a group of give-away tags (e.g., all give-away tags on the same roll) by tapping only one wireless tag in the group.

At 120, the user may use a mobile device to communicate with the single tag or the group or subgroup of tags. The mobile device includes a reader that transmits and receives radio signals at a wavelength or in a wavelength band that can be received and transmitted by the tag(s). When the tag(s) are NFC tag(s), the reader hovers over a wireless tag (e.g., about 0-10 cm away from the tags), and the mobile device receives identification, security, and/or sensor information from the wireless tag and displays a response screen that may display some or all of such information. In addition, the screen or display may direct the user to a configuration website for associating the tag with a user account (when the tag[s] are give-away tag[s]) and for assigning the tag(s) to a product.

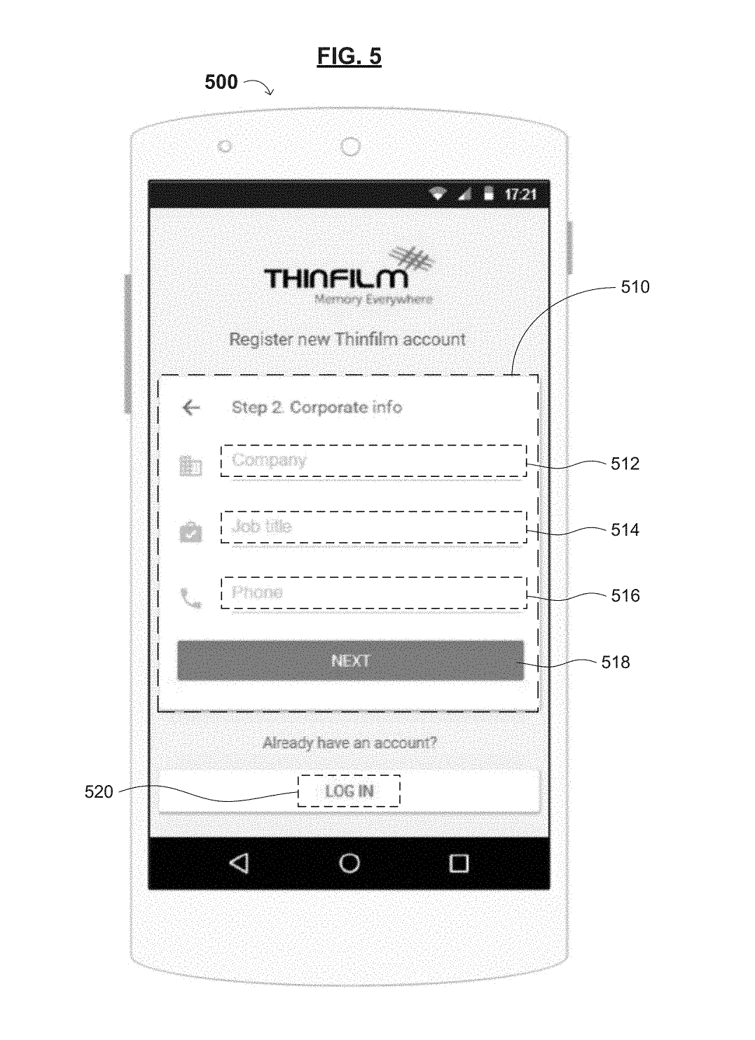

At 130, the user may navigate to the configuration website on the mobile device. Alternatively, the mobile device may automatically navigate to the configuration website. The configuration website may contain screens (or cause such screens to be displayed) substantially similar to the GUIs described with respect to FIGS. 5-10.

At 140, if the corresponding tag configuration application is not already installed on the mobile device, the user may be prompted to install the tag configuration application on the mobile device. The tag configuration application enables the user to assign one or more tags to a product, as well as manage or edit tag information and/or product information on the mobile device. If the user chooses to install the configuration application, the method proceeds to 150. If the user chooses not to install the configuration application, the method proceeds to 160.

At 150, if the configuration application is not installed on the mobile device, the user may install the configuration application on their mobile device using the configuration website. The user may be first prompted to agree to a user license before permission to download and install the configuration application is granted on the configuration website. After installation, the configuration application may launch automatically (or after user permission is granted), and the method proceeds to 170.

At 160, the configuration website may check if the user is logged in (e.g., using the configuration application on the mobile device). If the user is logged in, the flow chart proceeds to 180. If the user is not logged in, the method proceeds to 170.

At 170, the user is prompted to register or log into a user account with the configuration website or the configuration application. If the user does not have a user account, the user is prompted to register (e.g., create a user account by entering a unique username and a password). If the user has a user account, the user is prompted to log into his or her user account. The mobile device may display text fields for entering a username and/or a password, a button for logging in, a button that navigates the user to a screen for registering a new account, and buttons that navigate the user to screens for recovering forgotten or lost usernames and/or passwords. The configuration website or the configuration application (or other software on the mobile device) may remember or store the username or password. Selecting a text field may cause a keyboard or other information entry mechanism to appear on the screen or display of the mobile device.

At 180, the user may confirm that they wish to associate one or more wireless tags with their user account. The method then proceeds at 210 in FIG. 2. FIG. 2 shows a flow chart 100-B for an exemplary method of assigning one or more tags with a product. FIG. 2 is a continuation of the flow chart in FIG. 1.

At 210, the user may be prompted to configure the one or more wireless tags. If the user chooses to configure the wireless tag(s), then the method proceeds to 220. If the user chooses not to configure the one or more wireless tags, then the method returns to 110 in FIG. 1.

At 220, the user may assign the wireless tag(s) to a new product or a current product. A new product may be a product of, associated with, or known to the user, but to which the user has not previously assigned tags using the user account. A current product may be a product that already exists in the user account.

At 230, the user may be prompted to assign the wireless tag(s) to a current product. If the user chooses to assign the wireless tag(s) to a current product, the method proceeds to 260. If the user chooses to assign the wireless tag(s) to a new product, the method proceeds to 235 or 240.

At 235, the user may define a new product by entering a name of the new product, manually entering a uniform resource locator (URL) for the new product, or selecting a new product from a list of previous or favorite products. The user may enter a name of the new product by typing the name into a text field on the screen of the mobile device. The user may manually enter a URL for the new product by typing the URL into a different text field on the screen of the mobile device. The user may select a new product from a list of previous or favorite products from a drop-down or scrollable list displayed on the screen of the mobile device.

Alternatively, at 240, the user may define a new product by scanning a quick response (QR) code or a universal product code (UPC) for the new product, scanning a different tag that has been previously assigned to the new product, or describing the new product using voice or image recognition on the mobile device. Scanning a QR code or a UPC may automatically assign the tag(s) to the product identified by the code. Voice recognition software on the mobile device may convert words spoken into a microphone on the mobile device into readable text, and store the readable text as the name for a product. Image recognition software on the mobile device may compare an image of the new product to images in a database of product images. If the image of the new product is substantially similar to an image in the database, the new product may be defined as the product in the image in the database.

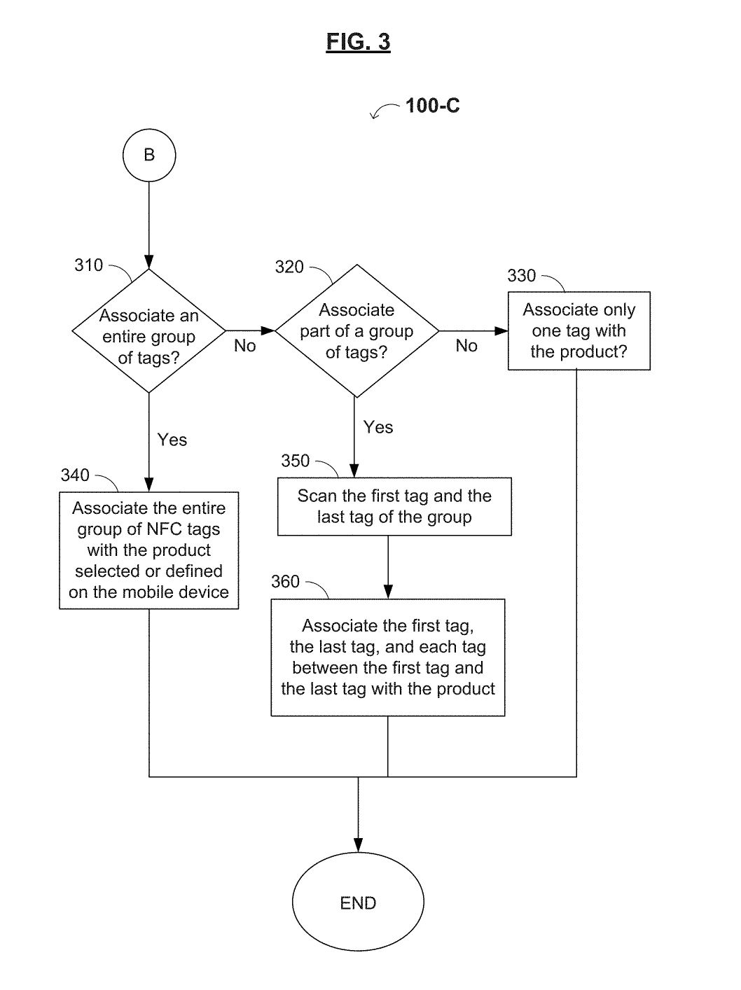

At 250, the configuration application may prompt the user to upload information regarding the new product (e.g., information describing the new product input in step 235 or 240) to a storage server or cloud computer using the mobile device and a network to which the mobile device is connected. In addition, the new product information may include instructions for use and/or assembly, warnings regarding improper usage, manufacturing and/or expiration information, etc. The method then proceeds to 310 in FIG. 3.

At 260, when the user wishes to assign the tag(s) to a current product, the user may select the current product from a drop-down list or a searchable list of current products to assign the wireless tag(s) to the current product. Alternatively, the user may scan a tag already assigned to the current product to assign the new tag(s) to the same product. In one embodiment, the user may be prompted to navigate to a screen or display enabling the user to edit information regarding the current product assigned to the wireless tag(s). The flow chart then proceeds to 310 in FIG. 3.

FIG. 3 shows a flow chart 100-C that enables the user to define how many tags are assigned to the new or current product. FIG. 3 is a continuation of the flow chart in FIG. 2.

At 310, the user may be prompted to assign a group of wireless tags (e.g., wireless tags on the same sheet or roll) with a product. The group of wireless tags may be all tags on a sheet or in a roll, for example. A sheet of tags may comprise an array of n rows and m columns of tags, where n and m are each independently an integer of at least 2 (e.g., 2, 3, 4, 6, 8 or more). A roll of tags may comprise an x-by-1, x-by-2, x-by-3, etc., roll of tags, where x is the number of rows in the roll and is an integer of at least 4 (e.g., 4, 6, 8, 10, 20, 10, 100 or more), and 1, 2, 3, etc., is the number of tags in each row. If the roll-to-roll processing equipment used to manufacture the tags is sufficiently sophisticated, it is possible that the roll can include more than 3 tags in each row. Generally, the tags are manufactured in bulk, and may be sold or given away as commodity items. Therefore, tags can be purchased, shipped and assigned in sheets or rolls. If the user chooses to associate or assign the group of wireless tags with the product, the method proceeds to 340. If not, the method proceeds to 320.

At 320, the user is prompted to assign a part or subgroup of the group of wireless tags with a product (e.g., using the screen on the mobile device). If the user chooses to associate or assign a part or subgroup of the group of wireless tags with the product, the method proceeds to 350. If not, the method proceeds to 330.

At 330, the user chooses to assign only one wireless tag with a product. In the case of an NFC tag, the user then brings the mobile device to a distance of 0-10 cm (or, in one example, 0-5 cm) from the tag. When the mobile device displays a screen, pop-up image, or other indicator of a response from the tag, the tag is assigned to the product. In the case of an RFID, HF, VHF or UHF tag, the user may press or tap on a command button, icon or bar on the screen to instruct the mobile device to send a wireless signal to the tag, which is backscattered by the tag or absorbed by the tag (in which case the tag then transmits a wireless signal back to the mobile device). When detected by the mobile device, the backscattering or transmission indicates to the mobile device that the tag has received and replied to the communication, and an indication that the tag is assigned to the product is displayed on the mobile device.

At 340, the user chooses to assign the entire group of wireless tags to the product. For example, the mobile device may navigate to a screen for assigning the entire group of tags to a single product. In one embodiment, the user taps or otherwise communicates with any tag in the group, the mobile device displays an indicator confirming the communication with the tag, and the whole group of tags is assigned to the product. In an alternative embodiment, the user may tap or communicate with a predetermined number of tags in the group (e.g., from 2 to n tags, where n is an integer of 3 or more), and the mobile device displays an indicator confirming the assignment of the whole group of tags to the product after communicating with the predetermined number of tags. Depending on the configuration of the application or web-browser software, the user may be prompted to scan or tap 3 or more tags in the group to assign the entire group of tags to the product, to distinguish this process from scanning or tapping 2 tags to assign a subgroup of tags to a product (see step 350 and the discussion thereof). The assignment may be uploaded to a storage server or cloud computer using the mobile device and a network to which the mobile device is connected.

At 350, the user defines a part or subgroup of the group of wireless tags (e.g., a subgroup) by scanning the first tag and the last tag of the subgroup of tags. The mobile device may display a screen with a first prompt to scan the first tag, then a second prompt to scan the last tag. At 360, the first tag, the last tag, and all of the tags between the first tag and the last tag are included in the part or subgroup of the group of wireless tags assigned to the product. For an x-by-1 roll of tags, scanning the first and last tags easily defines the subgroup of tags. For an x-by-2 roll of tags, scanning the first and last tags may define a subgroup that includes all tags in all rows that include the first tag, the last tag, and all tags in between. If the first and last tags are in the same column, the user may indicate that only tags in that column are assigned. For a sheet of tags, tapping the first tag and the last tag may assign the first tag, the last tag, and all tags between the first tag and the last tag in sequence to the subgroup. Alternatively, tapping 4 tags on the sheet may assign a subarray of the tags (e.g., a p-by-q subarray of an m-by-n array, where p is less than m and q is less than n) to the product, where the 4 tags define corners of the subarray. In such an embodiment, each of two pairs of the tags are in the same row, and each of two pairs of the tags are in the same column. The assignment of the subgroup of wireless tags to the product may be uploaded to a storage server or cloud computer using the mobile device and a network to which the mobile device is connected. After 330, 340, or 360, the method ends.

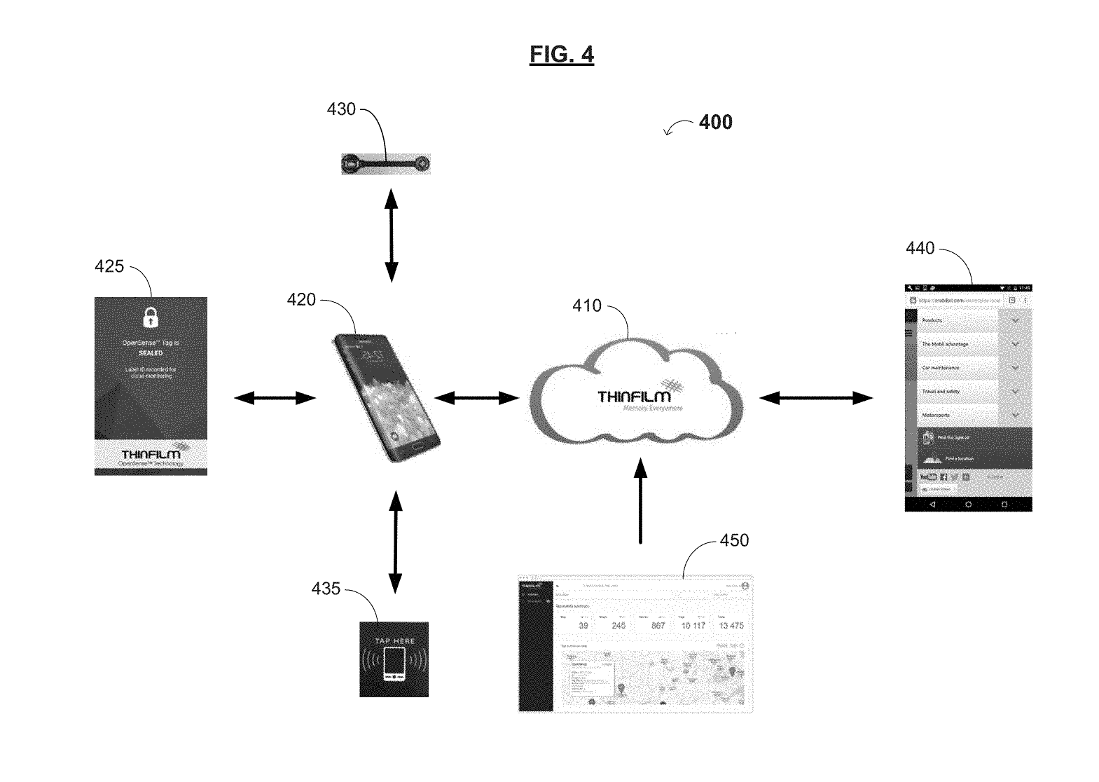

FIG. 4 shows an exemplary system 400 for associating one or more wireless tags with a user and assigning the tag(s) to one or more products. The system includes a cloud computer 410, a mobile device 420, a mobile application 425, a wireless security (e.g., continuity sensing) tag 430 or a wireless identification tag 435, a product website 440, and a portal application 450.

The cloud computer 410 may provide shared computer processing resources and data to the other devices in the system, and may be implemented using a cloud computing service such as Google Cloud Platform™ or Amazon Web Services™. The cloud computer 410 may be implemented using a service model such as software as a service (SaaS). Some or all of the data may be accessed by authorized users, but is protected from access by unauthorized users.

In the SaaS service model, the tag manufacturer applications (e.g., the mobile application 425 or the portal application 450) may be partially executed using the cloud computer 410. The tag manufacturer applications are accessible from various client devices (such as the mobile device 420) through either a web browser or a program (e.g., application) interface. The manufacturer, distributor, reseller, or end-user does not manage or control the underlying infrastructure in the cloud computer 410, including the network, servers, operating systems, and/or storage devices.

The mobile device 420 may be a smartphone, mobile phone, cellular phone, laptop computer, netbook computer, tablet computer, electronic pad, e-reader, personal digital assistant (PDA) or any other mobile electronic device with the ability to read wireless tags or connect to a device that reads wireless tags. The mobile device 420 may include a processor configured to fetch and execute instructions, volatile memory (e.g., random access memory) and nonvolatile memory (e.g., a hard disk drive) configured to store instructions and data, and a screen or display (e.g., a touchscreen). The mobile device may include software (e.g., in the nonvolatile memory) such as the mobile application 425 and/or the portal application 450, in addition to an operating system (e.g., the Microsoft® Windows® or Apple® iOS operating system) and a web browser (e.g., the Google Chrome™ browser).

The mobile application 425 may be a standalone application (e.g., an application downloaded from the Apple® App Store®) or a web application (e.g., an application that is executed on a web browser). The mobile application 425 may include functionality to configure, view, edit, and manage wireless tag and product information after logging into or registering a user account. The mobile application 425 may include a graphical user interface (GUI) and algorithms to implement the methods described with respect to the flow charts 100-A, 100-B, and 100-C in FIGS. 1-3 and elsewhere herein, including associating one or more wireless tags with the user account, and assigning one or more wireless tags to a current product or a new product. The mobile application 425 may also include an analytics screen that displays the number of tag communication events over various time periods (e.g., 10 taps per day or 2300 taps per month) and/or locations (e.g., 230,000 tag communication events in New York City for all time for one or more products or one or more tags or groups of tags).

If the mobile application 425 is implemented as a standalone application, the mobile application 425 may display a response message on the mobile device 420 after communicating with the wireless tag 430 or 435 using a reader in or connected to the mobile device 420. If the mobile application 425 is implemented as a web application, the mobile application 425 may not display a response message on the mobile device 420 after communicating with the wireless tag 430 or 435. However, the web application may still include functionality to configure, view, edit, and manage wireless tag and product information.

The wireless security tag 430 may detect whether a package or container (e.g., a box, a jar, a tray with a lid, or a bottle) is opened or closed. The wireless security tag 430 may include (i) a substrate and (ii) an integrated circuit and an antenna on the substrate. The substrate may be on a product or on or in product packaging. The integrated circuit may include a processor for executing instructions, a continuity sensor, and a memory. The wireless security tag 430 may further include an electrically conducting trace over an interface in the package or container (e.g., perpendicular to and across the gap between two flaps on a box or between a bottle and a cap or a cork). When the electrically conducting trace is broken by opening the package or container, the continuity sensor in (or in communication with) the integrated circuit detects the continuity state of the package or container as open, and a value representing the open continuity state is stored in the memory. Such wireless security tags are described in U.S. Pat. No. 9,519,904 (Attorney Docket No. IDR4590), the relevant portions of which are incorporated herein by reference. A reader can communicate with the wireless security tag 430 using the antenna, and retrieve information from the memory such as the value representing the continuity state or an identifier. The memory may also store other information such as an identifier, values of other sensors (e.g., temperature, humidity, chemical sensors, etc.), overhead bits, etc. Using the mobile application 425, the user may configure information for products assigned to the wireless security tag 430.

The wireless identification tag 435 may include a substrate, and an integrated circuit and an antenna on the substrate. The substrate may be on a product or on or in product packaging. The integrated circuit may include a processor for executing instructions and a memory. The memory may store information such as an identifier. In one embodiment, the wireless tags 430 and 435 are manufactured using printed doped polysilicon (PDPS) technology (see, e.g., U.S. Pat. No. 7,314,513 [Attorney Docket No. IDR0302], U.S. Pat. No. 7,485,691 [Attorney Docket No. IDR0422], U.S. Pat. No. 8,846,507 [Attorney Docket No. IDR0884], U.S. Pat. No. 9,045,653 [Attorney Docket No. IDR1102], and U.S. Pat. No. 9,359,513 [Attorney Docket No. IDR1942], the relevant portions of which are incorporated herein by reference). When such tags include memory made using such technology that stores identification information, the memory may not be rewriteable, limiting opportunities for fraud. A reader can communicate with the wireless identification tag 435 using the antenna, and retrieve information from the memory such as the identifier. The identifier may be used to confirm the authenticity of the product (e.g., to confirm that the product is not counterfeit). The wireless identification tag 435 can also be used to obtain product information (e.g., instructions for use and/or assembly, suggestions for complementary products, a prompt or icon for reordering the product, etc.). Using the mobile application 425, the user may configure information for products assigned to the wireless identification tag 435.

The product website 440 may be customized for each product to which one or more tags are assigned. A tag user (or configurer) may identify a URL or other website address to which subsequent users (e.g., of the product) are directed when they communicate with the tag. For example, when a user of the product communicates with a wireless tag 430 or 435, the mobile device 420 navigates to the product website 440, which may display a particularized response to the wireless tag communication (e.g., information that the tag user has assigned to the product).

The product user experience may be tailored by the tag user. For example, if the cloud computer 410 determines that the user has opened a predetermined number (e.g., 10 or more) of packages or containers sealed with the wireless security tag 430, the product website 440 may offer a coupon to the user (e.g., “For purchasing and opening 10 of our products, you have received a coupon for a 25% discount on an order of 5 or more products!”). If the user opens a package or container sealed with the wireless security tag 430 during a holiday season, the product website 440 may display a greeting message (e.g., “Merry Christmas!”). If the user opens a package or container sealed with the wireless security tag 430 having a temperature or humidity sensor, the product website 440 may display a suggestion to store the product at its proper temperature or humidity (e.g., “The product has been exposed to a temperature greater than 35° C. and may not be as effective as advertised or expected,” or “The product has been exposed to a relative humidity greater than 55%”).

The portal application 450 may be implemented as a standalone application or a web application. The portal application 450 may include a screen to log into or register the user account, assign previously scanned wireless tags to products, edit wireless tag information such as URLs associated with a particular product, and track, edit, or place orders of wireless tags. The portal application 450 may also include an analytics program that displays the number of tag communication events over various time periods (e.g., 10 taps per day or 2300 taps per month) and/or in various locations (e.g., 230,000 tag communication events in New York City). The analytics program may also display a map that shows markers or beacons for each tag communication event or each location of one or more tag communication events.

FIGS. 5-11B show displays or screens of an exemplary implementation of the mobile application 425.

FIG. 5 shows an exemplary log-in or registration screen 500 displayed on a mobile device for logging into or registering a user account. The registration portion of the log-in or registration screen 500 comprises a registration field 510 that includes a company text field 512, a job title text field 514, a phone number text field 516, and a continue button 518. The registration screen 500 also includes a log-in button 520. The user may type or enter the name of their company or organization in the company text field 512, his or her job title into the job title text field 514, and his or her phone number into the phone number text field 516 using an on-screen keyboard that is displayed when the user types or touches the text field. Tapping or touching the continue button 518 navigates the user to a screen for confirming the registration of the user account. Tapping or touching the log-in button 520 navigates the user to a screen for entering or typing a user name and a password for logging into a previously registered user account.

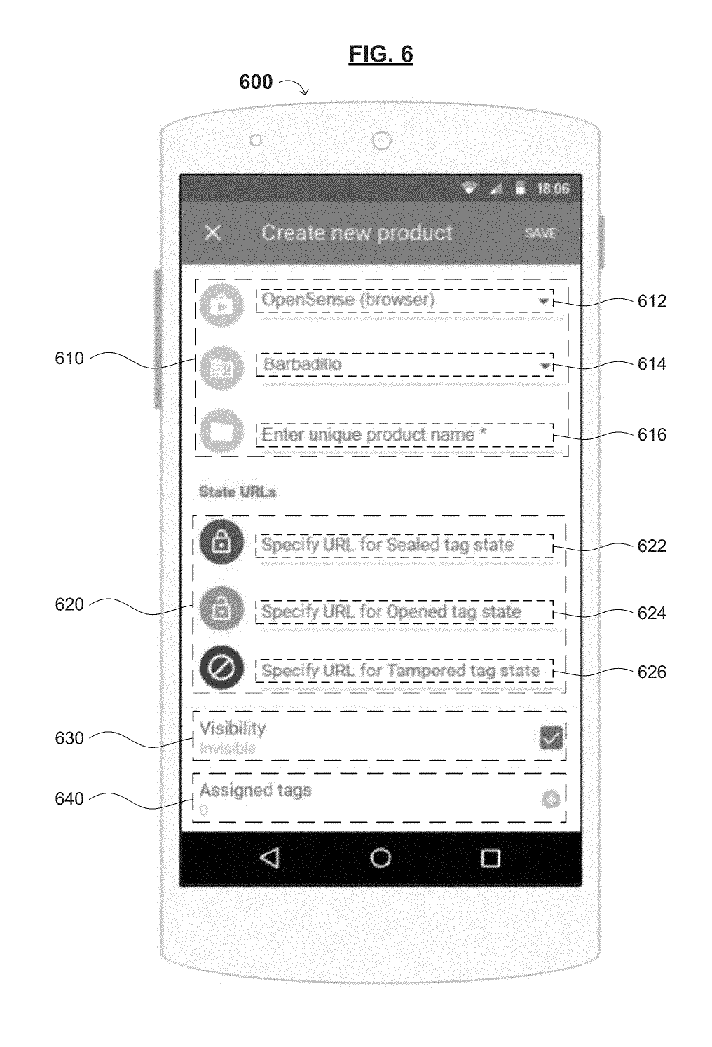

FIG. 6 shows an exemplary new product screen 600 displayed on the mobile device for defining a new product. The new product screen 600 comprises a new product information field 610 that includes a tag type drop-down menu 612, a product type drop-down or scrollable menu 614, a product name text field 616, a uniform resource locator (URL) field 620, a visibility indicator 630, and an assigned tags indicator 640. The URL field 620 includes a text field 622 for entering a URL to which the mobile device navigates when the tag has a first state, a text field 624 for entering a URL to which the mobile device navigates when the tag has a second state, and a text field 626 for entering a URL to which the mobile device navigates when the tag has a third state. Fewer or greater than 3 text fields may be included in the URL field 620, depending on the number of different tag states available and/or the desired user experience when the tag has a different state.

The tag type drop-down menu 612 allows the user to select the type of wireless tag to be associated with the new product (e.g., a wireless security tag or a wireless identification tag). The product type drop-down menu 614 allows the user to select a category, type or brand of the new product (e.g., wine or distilled spirits, clothing, a pharmaceutical product, a line or brand name of jewelry, etc.). The product name text field 616 allows the user to enter or type a name for the new product.

The first tag state text field 622 allows the user to enter a URL that provides product information when the tag has a first state. For example, when the tag is a security tag (e.g., tag 430 in FIG. 4), the first state of the tag may correspond to a continuity sensor determining that the product container is in a sealed state. The URL in such a case may authenticate the product as genuine or factory-sealed, and may provide instructions for opening the container. Alternatively, when the tag is the wireless identification tag 435, the first state may correspond to the tag in a first location (e.g., a retail store), in which case the URL may show pricing information, a coupon, complementary product information (e.g., names, prices and/or availability of additional products that work with or complement the tagged product), etc.

The second tag state text field 624 allows the user to enter a URL that provides product information when the tag has a second state. For example, when the tag is a security tag (e.g., tag 430 in FIG. 4), the second state of the tag may correspond to a product container in an opened state. The URL in such a case may warn the user that the product packaging may have been compromised or tampered with. Alternatively, when the tag is the wireless identification tag 435, the second state may correspond to the tag in a second location (e.g., the user's home), in which case the URL may show product use or assembly instructions. The URL for the second state of the security tag may also provide instructions for assembling and/or using the product.

The third state text field 626 allows the user to enter a URL that provides different product information when the tag has a third state. For example, when the tag is a security tag (e.g., tag 430 in FIG. 4), the third state of the tag may correspond to a product container in a partially open state. The URL in such a case may indicate that some units of the product in the packaging have been opened and others are closed or sealed (e.g., in an array of individual compartments in a sealed tray of single-dose pharmaceuticals). Alternatively, when the tag is the wireless identification tag 435, the third state may depend on the location and/or time of the communication (e.g., on a national holiday in a particular country, the URL may show a holiday greeting; a predetermined time after the tag enters the second state, the URL may show an order form to place an order for more of the product, etc.). Alternatively, if the security tag can indicate open and closed states reversibly, and the product is a pharmaceutical or other product having a predetermined number of units (e.g., a bottle containing 30 doses of medication, a carton containing 12 eggs, or a box containing 25 chocolates), the third state can correspond to a number of openings and closings equal to the number of units in the product. In such a case, the URL may show an order form to place an order for more of the product and/or a form for the product user to provide feedback to the tag user regarding the qualities of the product and/or the user experience (e.g., with the system for providing product information to the product user).

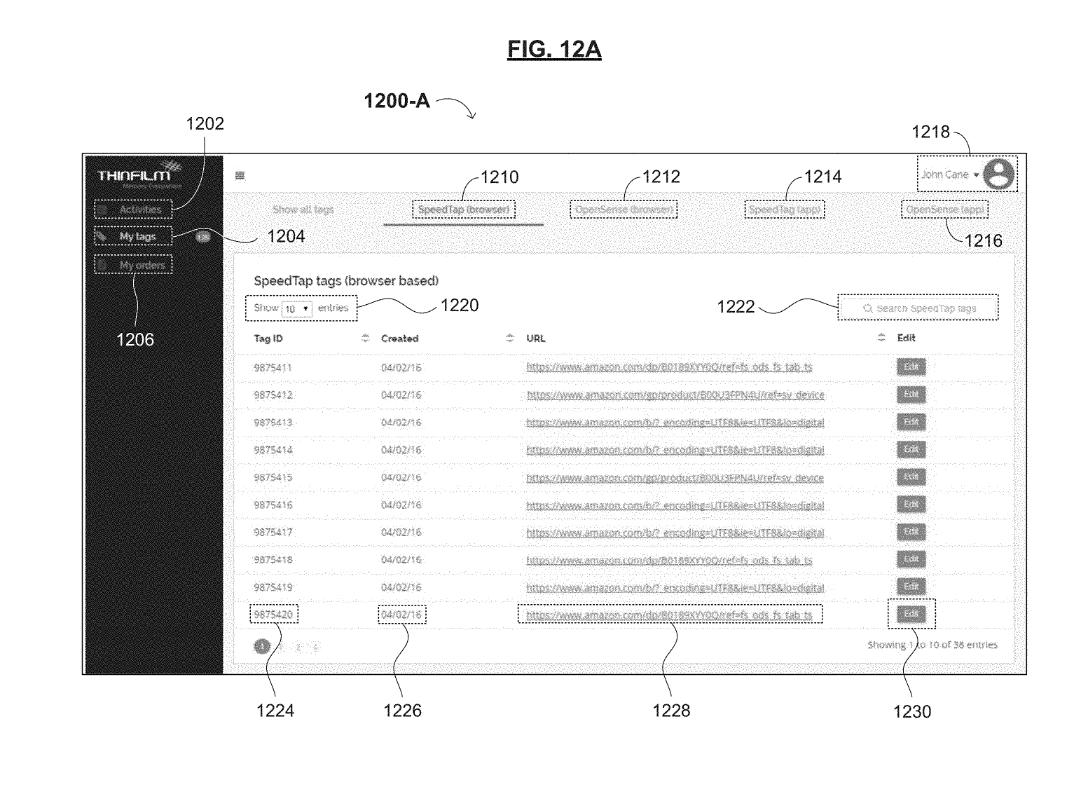

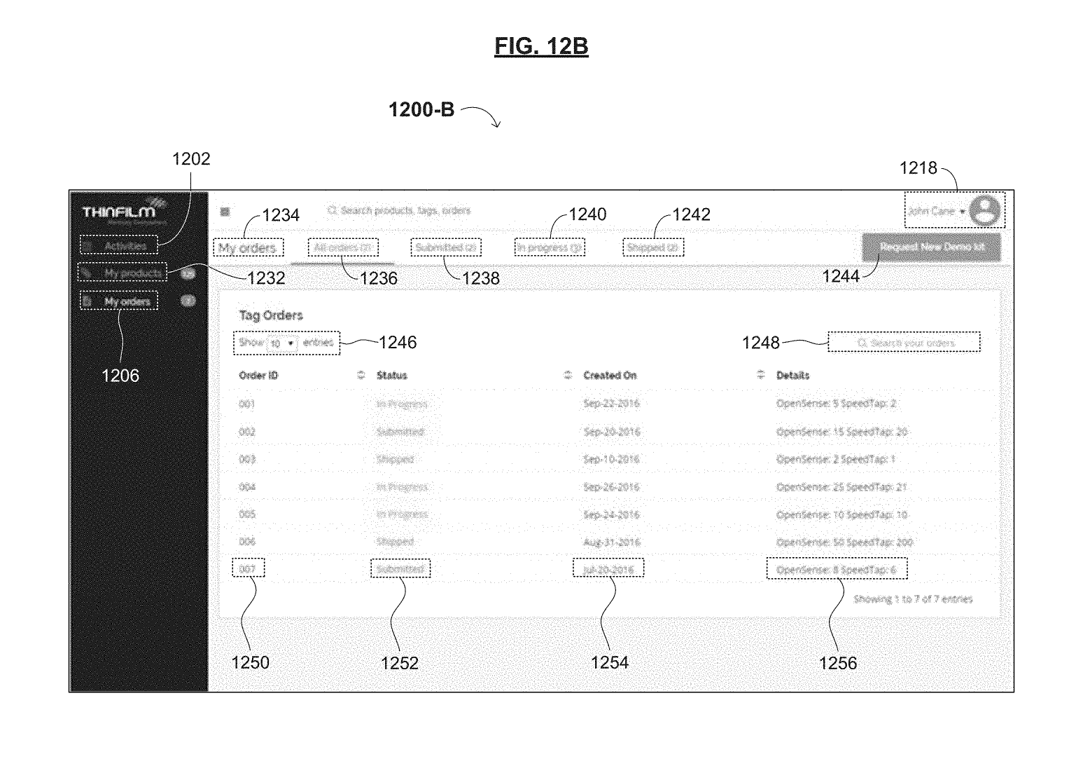

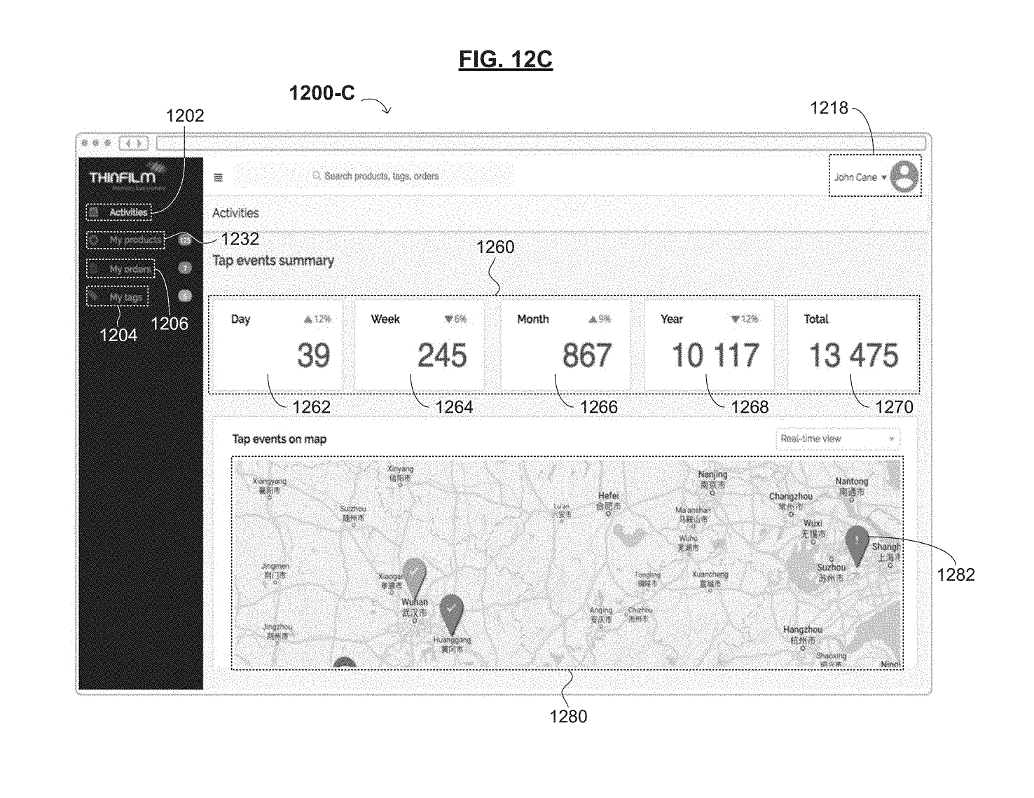

Activating the visibility indicator 630 may result in every communication with the tag appearing in the activities (see, e.g., the analytics screen 1200-C in FIG. 12C). If the visibility indicator 630 is not activated or checked, then communications with the tag will not show up in the activities. For example, using the visibility indicator 630, a tag that is used in a manufacturing line and with which a machine communicates or taps every several seconds can be excluded from the activities. The assigned tags indicator 640 allows the user to view the number and ultimately the identity of wireless tags currently assigned to the new product.

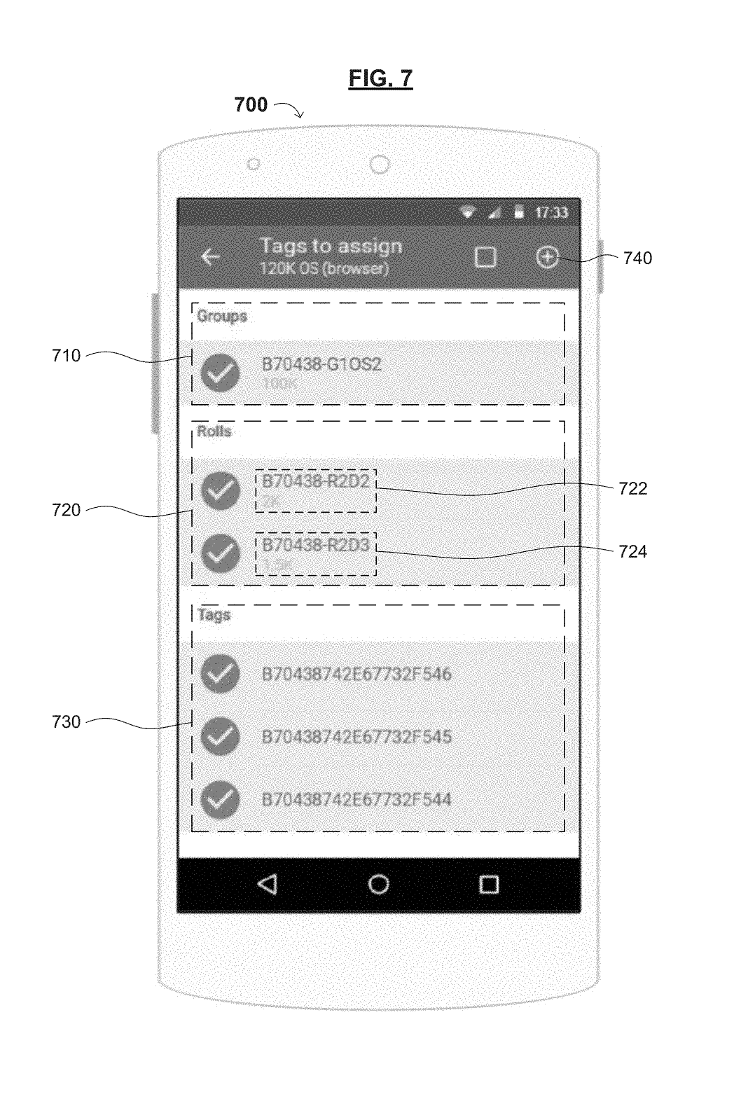

FIG. 7 shows an exemplary tag assignment screen 700 displayed on the mobile device for viewing the wireless tags to be assigned. The tag assignment screen 700 includes a tag group field 710, a tag roll field 720 that includes tag roll indicators 722 and 724, an individual tag field 730, and an “add tag(s)” icon 740.

The tag group field 710 allows the user to view groups of wireless tags associated with the user account that have yet to be assigned to a product. The groups of wireless tags may include a single sheet or roll of tags or multiple sheets or rolls of tags, and may include on the order of from 100 to 100,000,000 wireless tags. Touching or tapping on an identifier in the tag group field 710 navigates the user to a screen for assigning a group of wireless tags to a product. The tag group field 710 may display one or more groups of wireless tags. When multiple groups of tags are present or available, the user can scroll through the tag group field 710 to see groups of wireless tags that are not displayed.

The tag roll indicators 722 and 724 allow the user to view individual rolls or sheets of wireless tags associated with the user account that have yet to be assigned to a product. The individual roll or sheet of tags may include on the order of 10-10,000 wireless tags. Touching or tapping on an identifier in the tag roll indicator 722 or 724 navigates the user to a screen for assigning a roll, a sheet, or part of a roll or sheet of wireless tags to a product. The tag roll field 720 may display more or less than 2 rolls or sheets of wireless tags. If the tag roll field 720 includes 2 or more rolls or sheets, the user can scroll through the tag roll field 720 to see rolls or sheets of wireless tags that are not displayed.

The individual tag field 730 allows the user to view individual wireless tags associated with the user account that have yet to be assigned to a product. Touching or tapping on an identifier in the individual tag field 730 navigates the user to a screen for assigning an individual wireless tag to a product. The individual tag field 730 may display more or less than 3 wireless tags, and the user can scroll through the individual tag field 730 to see wireless tags that are not displayed.

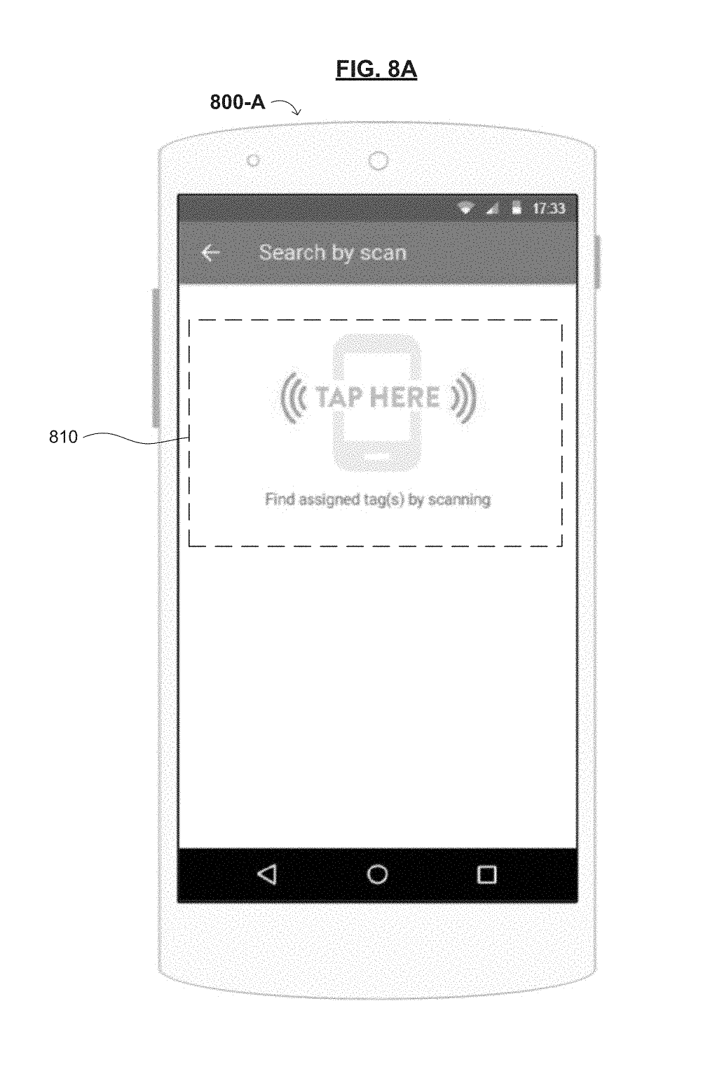

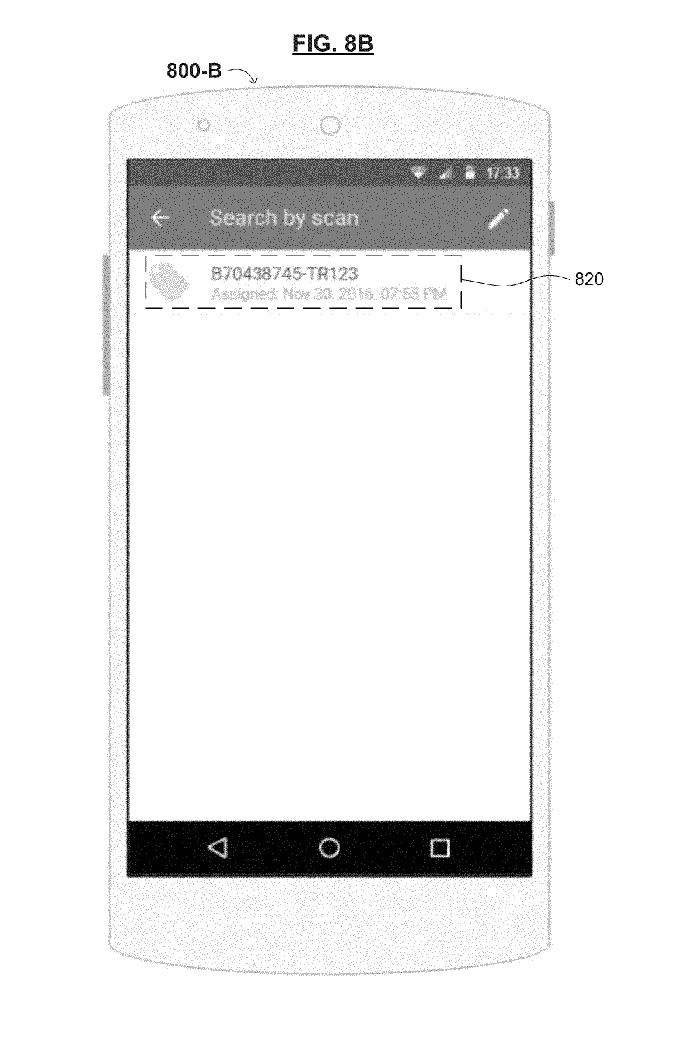

In FIG. 7, the “add tag(s)” icon 740 navigates to a tag scanning screen (not shown) similar to FIG. 8A. However, the tag scanning screen enables the user to scan one or more unassigned tags, instead of assigned tags as in FIG. 8A.

FIG. 8A shows an exemplary scan screen 800-A displayed on the mobile device for finding tags assigned to a product. When a scan indicator 810 appears on the scan screen 800-A, the user may place their mobile device or reader within a distance proximate (e.g., 5-10 cm) from one or more wireless tags in order to transmit and receive information to and from the tag. If the mobile device or reader successfully communicates with the wireless tag, the scan indicator 810 changes appearance, and the mobile device automatically navigates to a new scan screen (e.g., screen 800-B in FIG. 8B). Alternatively, the user may manually navigate to the new scan screen.

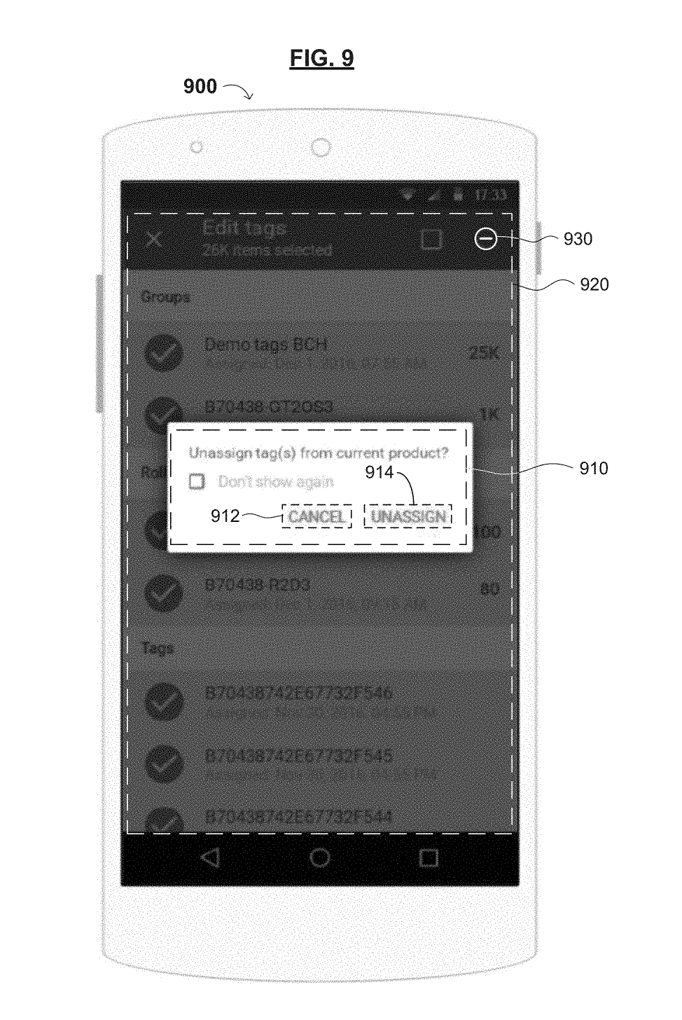

FIG. 8B shows an exemplary scan screen 800-B displayed on the mobile device for finding tags assigned to a product. A scanned tag indicator 820 shows the identifier and assignment status of the scanned wireless tag described in FIG. 8A. Optionally, the date and time of the product assignment is also shown on the scan screen 800-B. Touching or tapping on the scanned indicator tag 820 navigates the user to a screen for editing the assignment status of the wireless tag (e.g., tag editing screen 900 in FIG. 9).

FIG. 9 shows an exemplary tag editing screen 900 displayed on the mobile device for editing the assignment and/or assignment status of scanned and/or assigned wireless tags. Groups, sheets or rolls, and individual tags may be unassigned from current products in the tag editing screen 900. An unassign field 910 includes an unassign button 914 for unassigning a group, sheet, or roll of wireless tags or an individual wireless tag from a product, and a cancel button 912 to keep the assignment of the wireless tag(s). After unassigning a tag or tags or cancelling the unassignment, the screen 920 underneath the unassign field 910 becomes active and completely visible.

The screen 920 is similar to the tag assignment screen 700 in FIG. 7, but is used for selecting tag(s) to be edited or unassigned. A “remove tag(s)” icon 930 navigates to a tag scanning screen (not shown) similar to FIG. 8A. However, the tag scanning screen enables the user to scan one or more assigned tags instead of unassigned tag(s) and subsequently unassign such scanned assigned tag(s) from a product.

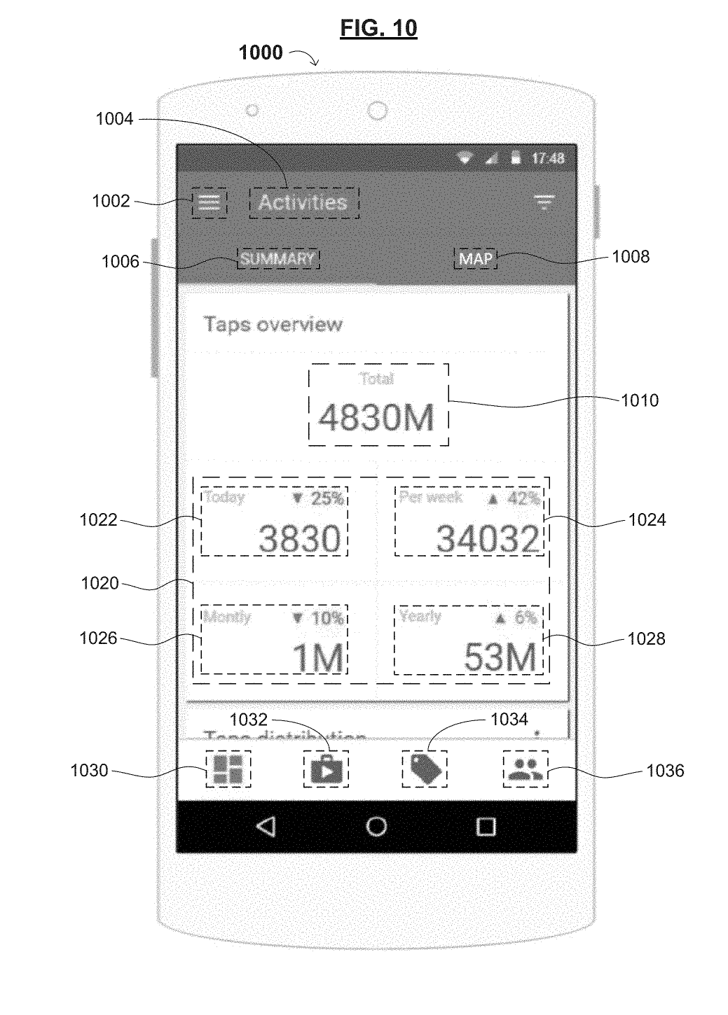

FIG. 10 shows an exemplary analytics screen 1000 displayed on the mobile device for tracking wireless tag communication events. When a user communicates with a wireless tag, the communication is logged as an event and stored on a server (or a storage device in communication with the server). The analytics screen 1000 includes a menu button 1002, a header 1004, a summary tab 1006, a map tab 1008, a total counter 1010, time period counters 1020, an analytics button 1030, a product management button 1032, a tag management button 1034, and an account button 1036. The time period counters 1020 include a day counter 1022, a week counter 1024, a month counter 1026, and a year counter 1028, but are not limited thereto. Alternatively, the time period counters 1020 include an hour counter, a cumulative counter (e.g., from a specified starting date), etc. More or less than 4 counters may be included in time period counters 1020.

Touching or tapping the menu button 1002 navigates the user to a menu screen that allows the user to access some or all of the various screens described with respect to FIGS. 5-10. The header 1004 displays the name of the screen. Touching or tapping on the summary tab 1006 navigates the user to the analytics screen 1000 (e.g., if the map tab 1008 had been previously selected). Touching or tapping on the map tab 1008 navigates the user to a screen displaying a map for viewing tag communication events in a particular area or location.

The total counter 1010 displays the total number of tag communication events for the assigned tag(s). The assigned tags may include all assigned tags, a subgroup of tags, or an individual tag for a particular product. The day counter 1022 displays the number of tag communication events for the assigned tag(s) for the current day. The week counter 1024 displays the number of tag communication events for the assigned tag(s) for the past week. The month counter 1026 displays the number of tag communication events for the assigned tag(s) for the past month. The year counter 1028 displays the number of tag communication events for the assigned tag(s) for the past year. Trends (e.g., the percentage increase or decrease in tag communication events relative to the previous time period) may also be displayed.

The analytics button 1030 navigates the user to the analytics screen 1000. The product management button 1032 navigates the user to a screen for managing or editing product information (e.g., URLs). The tag management button 1034 navigates the user to a screen for managing or editing wireless tag information (e.g., where the user may define one or more tag states). The account button 1036 navigates the user to a screen for configuring the user account, including updating information such as a name, phone number, address, company, organization, username and/or password for the account.

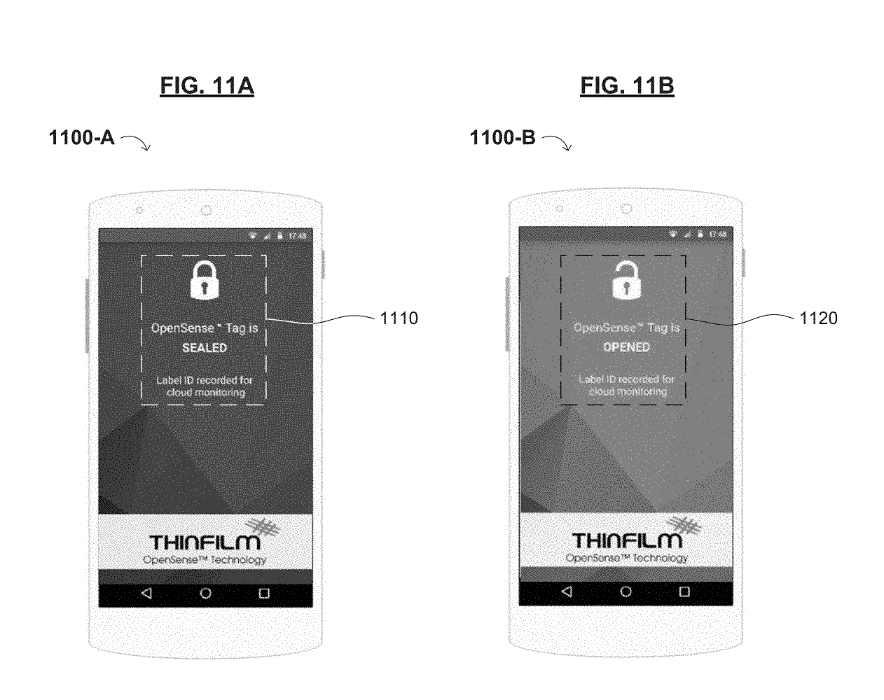

FIGS. 11A and 11B show exemplary response screens 1100-A and 1100-B. The response screens 1100-A and 1100-B are displayed on the mobile device after communicating with a wireless security tag such as security tag 430 (FIG. 4) using the reader. If the wireless security tag determines that a package or container is closed, the response screen 1100-A appears and displays a sealed indicator 1110. If the wireless security tag detects that the package or container is open, the response screen 1100-B appears and displays an opened indicator 1120.

FIGS. 12A-12C show an exemplary implementation of the portal application 450 described with respect to FIG. 4.

FIG. 12A shows an exemplary tag management screen 1200-A. The tag management screen 1200-A includes an activities management button 1202, a tag management button 1204, an order management button 1206, a first identification tag tab 1210, a first security tag tab 1212, a second identification tag tab 1214, a second security tag tab 1216, an account menu button 1218, a drop-down menu or filter 1220, a search field 1222, a tag identifier 1224, a tag creation date 1226, a product URL 1228, and a tag edit button 1230. The first identification tag tab 1210 and the first security tag tab 1212 display a screen with information that can be viewed and/or managed using a browser-based application or program. The second identification tag tab 1214 and the second security tag tab 1216 display a screen with information that can be viewed and/or managed using a mobile application. The tag management screen 1200-A displays information for identification tags using a browser-based application or program (i.e., in which the first identification tag tab 1210 has been selected.)

The activities management button 1202 navigates the user to a screen that displays information regarding the location and/or number of wireless tag communication events (e.g., screen 1200-C in FIG. 12C). The tag management button 1204 navigates the user to the tag management screen 1200-A. The order management button 1206 navigates the user to a screen for viewing and/or managing orders and/or shipments of wireless security and/or identification tags (e.g., order management screen 1200-B in FIG. 12B).

Touching or tapping the first identification tag tab 1210 displays all of the wireless identification tags associated with the user account (individually or as a group) and the product URLs assigned to each wireless identification tag using a first configuration application (e.g., one that is browser-based). Touching or tapping the first security tag tab 1212 displays all of the wireless security tags associated with the user account and the product URLs assigned to each wireless security tag using the first configuration application. The first identification tag tab 1210 and the first security tag tab 1212 are operational when using a web browser or a mobile application.

Touching or tapping the second identification tag tab 1214 displays all of the wireless identification tags associated with the user account (individually or as a group) and the product URLs assigned to the wireless identification tag(s) using a second tag configuration application (e.g., a mobile application). This display may further include a button, icon, or bar to communicate with one or more wireless identification tags (e.g., to retrieve identification and/or product information). Touching or tapping the second security tag tab 1216 displays all of the wireless security tags associated with a user account (individually or as a group) and the product URLs assigned to the wireless continuity sensing tag(s) using the second tag configuration application. This display may further include a button, icon, or bar to communicate with one or more wireless security tags (e.g., to retrieve identification and security information). The second identification tag tab 1214 and the second security tag tab 1216 may be operational only when using a standalone (e.g., mobile) application on a mobile device.

The account menu button or icon 1218 allows a user to log out or navigate to a screen for editing details of a user account (e.g., similar to screen 500 in FIG. 5). The drop-down menu or filter 1220 allows a user to select the number of wireless tags displayed per page on the tag management screen 1200-A. The search field 1222 allows a user to search for wireless tags that are currently assigned to a product (e.g., using an on-screen keyboard that appears when the search field 1222 is touched or otherwise selected). The tag identifier 1224 is a unique identification number for the wireless tag or group of wireless tags. The tag creation date 1226 is the date on which the tag or tag identifier 1224 was created. The tag URL 1228 is the URL to which a subsequent reader of the tag navigates for information about the product to which the wireless tag in 1224 is assigned. The tag edit button 1230 allows the user to edit the product name, or the tag URL 1228, etc. (e.g., by navigating to an editing screen such as screen 600 [FIG. 6] or screen 900 [FIG. 9]).

FIG. 12B shows an exemplary order management screen 1200-B that includes the activities management button 1202, the order management button 1206, the account menu button or icon 1218, a product management tab 1232, a header 1234, an “all orders” tab 1236, a “submitted orders” tab 1238, an “orders in progress” tab 1240, a “shipped orders” tab 1242, a request tab 1244, a drop-down menu or filter 1246, an order search field 1248, an order identifier 1250, an order status indicator 1252, an order date 1254, and order details 1256.

The product management tab 1232 navigates the user to a screen for adding, removing and/or editing current products and new products to which wireless tags are assigned. The header 1234 indicates that the user is on the order management screen 1200-B. Touching or tapping the “all orders” tab 1236 displays all of the orders of wireless tags that the user has placed with or requested from the wireless tag manufacturer. Touching or tapping the “submitted orders” tab 1238 displays all the orders of wireless tags that the user has submitted to the wireless tag manufacturer that the manufacturer has not yet processed. Touching or tapping the “orders in progress” tab 1240 displays all the orders of wireless tags that the user has submitted to the wireless tag manufacturer that the manufacturer has is currently processing. Touching or tapping the “shipped orders” tab 1242 displays all the orders of wireless tags that the user has submitted to the wireless tag manufacturer that the manufacturer has shipped. The request tab 1244 allows the user to request a wireless tag demonstration kit or other items and/or information from the wireless tag manufacturer.

The drop-down menu or filter 1246 allows a user to select the number of wireless tag orders displayed per page on the order management screen 1200-B. The order search field 1248 allows a user to search for wireless tag orders currently displayed on the order management screen 1200-B. In one example, the order search field 1248 comprises a text field that allows the user to perform a text search for one or more orders. Alternatively or in addition, the order search field 1248 can display a list of recent searches and/or recent orders upon touching or tapping the order search field 1248. The order identifier 1250 is a unique number that identifies a particular order of wireless tag(s). The order status indicator 1252 displays the current status of the corresponding wireless tag order (e.g., “Shipped” or “In Progress”). The order date 1254 displays the date on which the corresponding order was placed (or on which a request for one or more wireless tags was made to the manufacturer). The order details 1256 displays information about the corresponding order, such as the type(s) of wireless tags and/or the number of each type of tag (e.g., 5 security tags and 2 identification tags), etc.

FIG. 12C shows an exemplary analytics screen 1200-C that includes the activities management button 1202, the tag management button 1204, the order management button 1206, the account menu button or icon 1218, the product management tab 1232, counters 1260, a map 1280, and one or more beacons or markers 1282.

The counters 1260 include a day counter 1262, a week counter 1264, a month counter 1266, a year counter 1268, and a total counter 1270, but are not limited thereto. The total counter 1270 may display the total number of tag communication events for the assigned tag(s) cumulatively over all time. In the analytics screen 1200-C, the assigned tags may include all assigned tags, a subgroup of tags, or an individual tag for a particular product, as configured by the user of the analytics screen 1200-C (e.g., using a GUI that is not shown in the drawings). The day counter 1262 displays the number of tag communication events for the assigned tag(s) for the current day. The week counter 1264 displays the number of tag communication events for the assigned tag(s) for the past week. The month counter 1266 displays the number of tag communication events for the assigned tag(s) for the past month. The year counter 1268 displays the number of tag communication events for the assigned tag(s) for the past year. Trends (e.g., the percentage increase or decrease in tag communication events relative to the previous time period) may also be displayed. Alternatively, the counters 1260 include an hour counter, a cumulative counter (e.g., from a specified starting date), etc. More or less than 5 counters may be included in the counters 1260.

The map 1280 displays a country, state, province, region or location where a wireless tag communication event may occur. If one or more wireless tag communication events occur in the area displayed in the map 1280, the beacon or marker 1282 identifies the location of the event(s) on the map. In one embodiment, the user of the analytics screen 1200-C may set one or more thresholds (e.g., a minimum number of tag communication events, a range of tag communication events, a range of dates and/or times of tag communication events, etc.) to control when beacons or markers 1282 appear on the map. Touching or tapping on the beacon marker 1282 may display additional information such as the name of the product, the wireless tag identifier, dates and times of the tag communication events, the type of device used to communicate with the wireless tag, etc.

### CONCLUSION

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

What is claimed is:

1. A computer-implemented method for associating one or more wireless tags with one or more products, comprising:
communicating wirelessly with the one or more wireless tags using a mobile device;
associating the one or more tags with a user account using a configuration website or an application on the mobile device; and
assigning at least one of the one or more wireless tags to a current product or a new product using the configuration website or the application on the mobile device.

2. The method of claim 1, wherein each of the one or more wireless tags is a wireless identification tag, and each of the one or more wireless identification tags is an owned tag or a give-away tag.

3. The method of claim 2, wherein each of the one or more wireless identification tags is an owned tag, and the method further comprises associating the owned tag with the user account before the mobile device communicates with the owned tag.

4. The method of claim 1, comprising assigning the at least one of the one or more wireless tags to the new product, wherein assigning the at least one of the one or more wireless tags to the new product comprises entering a name for the new product, entering or typing a uniform resource locator (URL), selecting the new product from a list of previous or favorite products using a graphical user interface (GUI) on the mobile device, scanning a quick response (QR) code or universal product code (UPC) using the mobile device, scanning a different wireless tag assigned to the new product using the mobile device, or describing or defining the new product using voice or image recognition on the mobile device.

5. The method of claim 1, comprising assigning the at least one of the one or more wireless tags to the current product, wherein assigning the at least one of the one or more wireless tags to the current product comprises selecting the current product from a list of current products using a graphical user interface (GUI) on the mobile device.

6. The method of claim 1, wherein the one or more wireless tags comprises a group of wireless tags, and assigning the group of wireless tags comprises communicating with a first wireless tag and a last wireless tag in the group of wireless tags using the mobile device to assign the first wireless tag, the last wireless tag, and all wireless tags between the first wireless tag and the last wireless tag to the current product or the new product.

7. The method of claim 1, wherein the mobile device comprises a smart phone configured to communicate wirelessly with the one or more wireless tags.

8. A system for associating one or more wireless tags with one or more products, the system comprising:
the one or more wireless tags;
a mobile device configured to communicate wirelessly with the one or more wireless tags, the mobile device having a processor and a memory configured to store and execute an application configured to assign the one or more wireless tags to a product, display information regarding the one or more wireless tags and the product, and optionally associate the one or more wireless tags with a user account; and
a storage server or cloud computer configured to (i) send, receive and store the information regarding the one or more wireless tags and the associated product and (ii) store and execute an analytics program or web application configured to track the information regarding the one or more wireless tags.

9. The system of claim 8, wherein each of the one or more wireless tags is a wireless identification tag.

10. The system of claim 8, wherein the application is further configured to enable a user to register or sign in to the user account before the user can assign the one or more wireless tags to the product.

11. The system of claim 8, wherein the product is a new product, and the application is further configured to assign at least one of the one or more wireless tags to the new product by entering a name for the new product, entering or typing a uniform resource locator (URL), selecting the new product from a list of previous or favorite products using a graphical user interface (GUI) on the mobile device, scanning a quick response (QR) code or universal product code (UPC) using the mobile device, scanning a different wireless tag assigned to the same product using the mobile device, or describing or defining the new product using voice or image recognition on the mobile device.

12. The system of claim 8, wherein the product is a current product, and the application is further configured to assign at least one of the one or more wireless tags to the current product by selecting the current product from a list of current products displayed on a graphical user interface (GUI) on the mobile device.

13. The system of claim 8, wherein the one or more wireless tags comprises a group of wireless tags, and the application is configured to assign a first one of the group of wireless tags, a last one of the group of wireless tags, and all wireless tags between the first one and the last one of the wireless tags to the current product or the new product when the mobile device communicates with the first one of the wireless tags and a last one of the wireless tags.

14. The system of claim 8, wherein the mobile device comprises a smart phone configured to communicate wirelessly with the one or more wireless tags.

15. A tangible computer-readable storage medium storing a set of instructions, which when executed by a processor on a mobile device cause the processor and/or the mobile device to at least:
enable a user to communicate with one or more wireless tags using the mobile device;
after communicating with the one or more wireless tags, navigate to a configuration website or an application on the mobile device; and
enable the user to assign the one or more wireless tags to a current product or a new product using the configuration website or the application on the mobile device.

16. The computer-readable storage medium of claim 15, wherein each of the one or more wireless tags is a wireless identification tag, and each of the one or more wireless identification tags is an owned tag or a give-away tag.

17. The computer-readable storage medium of claim 16, wherein each of the one or more wireless identification tags is an owned tag, and the set of instructions further includes at least one instruction to associate the owned tag with the user account before the mobile device communicates with the owned tag.

18. The computer-readable storage medium of claim 15, wherein the set of instructions further includes at least one instruction to navigate to the configuration website or the application on the mobile device after the mobile device communicates with the one or more wireless tags.

19. The computer-readable storage medium of claim 15, wherein the set of instructions further includes at least one instruction to prompt a user to register or sign in to the user account using the configuration website or the application on the mobile device.

20. The computer-readable storage medium of claim 15, wherein the set of instructions further includes at least one instruction to assign at least one of the one or more wireless tags to a new product, and the at least one instruction to assign at least one of the one or more wireless tags to the new product comprises at least one instruction to enable the user to enter a name for the new product, enter or type a uniform resource locator (URL), select the new product from a list of previous or favorite products using a graphical user interface (GUI) on the mobile device, scan a quick response (QR) code or universal product code (UPC) using the mobile device, scan a different wireless tag assigned to the new product using the mobile device, or describe or define the new product using voice or image recognition on the mobile device.

21. The computer-readable storage medium of claim 15, wherein the set of instructions further includes at least one instruction to assign at least one of the one or more wireless tags to a current product, and the at least one instruction to assign the at least one of the one or more wireless tags to the current product comprises at least one instruction to enable the user to select the current product from a list of current products using a graphical user interface (GUI) on the mobile device.

22. A system for managing one or more wireless tags associated with one or more products, the system comprising:
the one or more wireless tags;
a mobile or stationary device configured to communicate with the one or more wireless tags, the mobile or stationary device comprising a program or web application configured to access, track and manipulate information regarding the one or more wireless tags and a product associated with the one or more wireless tags; and
a storage server or cloud computer configured to send, receive or store the information regarding the one or more wireless tags and the associated product.
